(19) United States
(12) Patent Application Publication
(10) Pub. No.: US 2005/0100372 A1
(43) Pub. Date: May 12, 2005

(54) Image forming apparatus having fixing device

(75) Inventor: Hiroshi Fuma, Uenohara-machi (JP)

Correspondence Address: COHEN, PONTANI, LIEBERMAN & PAVANE, 551 FIFTH AVENUE, SUITE 1210, NEW YORK, NY, 10176, US

(73) Assignee: Konica Minolta Business Technologies, Inc., Tokyo (JP)

(21) Appl. No.: 10/916,080

(22) Filed: Aug. 11, 2004

(30) Foreign Application Priority Data
Nov. 7, 2003 (JP) JP2003-378063

(51) Int. Cl. G03G 15/20

(52) U.S. Cl. 399/329

(57) ABSTRACT

An image forming apparatus containing a fixing device for fixing on sheet a toner image formed on the sheet by applying heat and pressure. This fixing device includes a belt having an elastic layer for applying heat and pressure to the sheet, and a first pressure roller and a second pressure roller, located opposite to each other with the paper interposed in between, for applying pressure to the belt and sheet. The first pressure roller, having no elastic layer on the outer periphery, is arranged inside the belt, and support points of a support member for supporting the first pressure roller is located within a width of the sheet passing through.

The present invention relates to an image forming apparatus, such as a copying machine, printer and facsimile machine, where image formation is performed by electrophotographic technology.

### BACKGROUND OF THE INVENTION

Generally, in an image forming apparatus based on electrophotographic technology, a toner image is formed on a photoconductor, and this toner image is transferred on a transfer material such as paper. Then the paper carrying the transferred toner image is fed to fixing means, which applies pressure and heat, whereby the toner image is fixed onto the paper.

To apply pressure and heat by the fixing means, a heat roller fixing method has often been used, wherein a heating roller, incorporating a heat source, with an elastic layer on the surface, and a pressure roller, located opposite to the heating roller, for pressing the heating roller at a predetermined pressure are provided, and the paper carrying a toner image is interposed between these two rollers and is fed under pressure and heat.

To meet the recent requirements for reduced warm-up time and lower power consumption, the fixing means in the aforementioned heat roller fixing method is required to achieve a lower heat capacity, with the result that a heating roller core has to be made thinner. However, a thinner roller core reduces the mechanical strength of the heating roller, and has brought about new problems such as longitudinal bending of the roller and deformation of the cross section.

To cope with these new problems, a proposal has been made to install a reinforcing member having a plurality of small rollers in contact at multiple positions, with the outer periphery of the heating roller (e.g. Patent Japanese Patent Application Laid-open Publication No. Tokkai 2001-296770). However, the pressure of the pressure roller is restricted to a very small range due to smaller thickness.

In order to meet the requirements for color copying as well as reduced warm-up time and lower power consumption, fixing means based on a belt fixing method has also come into widespread use, wherein a belt, having an elastic layer, entrained about the heating roller and pressure roller and a second pressure roller for pressing the aforementioned pressure roller through this belt from the outside are provided, and heat and pressure are applied to the paper carrying a toner image, by a nip formed by the belt and second pressure roller.

Although the belt itself used as a heating member in the fixing means based on the belt fixing method substantially reduces heat capacity as compared to the heating roller used in the heat roller fixing method, the pressure roller placed opposite to the second pressure roller with the belt sandwiched in-between must have the thickness and outer diameter that ensures sufficient strength to withstand applied pressure. This arrangement requires the member having a large heat capacity to come into contact with the belt, and has made it difficult to reduce heat capacity. In practice, it is also necessary to heat the aforementioned pressure roller, with the result that the effect of reducing the heat capacity by use of a belt is much weakened.

To solve these problems, a proposal has been made to use a sliding pad in place of the pressure roller, thereby preventing the heat capacity from increasing. Actually, an image forming apparatus using the fixing means according to this method has been introduced into the market. This proposal, however, is now confronted with a new difficult problem of meeting the requirements for higher speed and greater durability.

### SUMMARY OF THE INVENTION

In view of the prior art described above, it is an object of the present invention to provide fixing means characterized by a high degree of fixing performance and low heat capacity capable of meeting the needs of a high-speed image forming apparatus, where the diameter of the pressure roller is reduced by improving the configuration of a support member for supporting a pressure roller about which a belt is entrained, and the support position thereof, whereby the heat capacity of the support roller is reduced.

The aforementioned object can be achieved by any one of the following structures (1) and (2):

(1) An image forming apparatus containing fixing means for fixing on paper a toner image formed on the paper by applying heat and pressure. This fixing means comprises a belt having an elastic layer for applying heat and pressure to the paper, and a first pressure roller and a second pressure roller, located opposite to each other with the paper interposed inbetween, for apply pressure to the belt and paper. This image forming apparatus is characterized in that the first pressure roller, having no elastic layer on the outer periphery, is arranged inside the belt, and the support point of the support member for supporting the first pressure roller is located within the width of the paper passing through.

(2) An image forming apparatus containing fixing means for fixing on paper a toner image formed on the paper by applying heat and pressure. This fixing means comprises a belt having an elastic layer for applying heat and pressure to the paper, and a first pressure roller and a second pressure roller, located opposite to each other with the paper interposed inbetween, for apply pressure to the belt and paper. This image forming apparatus is characterized in that the first pressure roller, having no elastic layer on the outer periphery, is arranged inside the belt, and is supported at plural support points by the support member having plural roller pairs.

In the fixing means using a belt, the invention described in the aforementioned structure (1) avoids the bending of the first pressure roller about which the belt is entrained, where the aforementioned bending is caused by reduced diameter, and reduces the heat capacity. At the same time, this invention allows uniform and sufficient pressure to be applied to the paper carrying a toner image, whereby more preferable image fixing is ensured. Further, the separation performance from the belt of the paper in which the image has been fixed, can be enhanced.

In the fixing means using a belt, the invention described in the aforementioned structure (2) provides heating roller support means that uses a simple method to reduce the diameter of the first heating roller about which the belt is entrained.

### BRIEF DESCRIPTION OF THE DRAWINGS

FIG. 1 is a schematic drawing of an image forming apparatus;

FIG. 2 is a block diagram representing the control of an image forming apparatus;

FIG. 3 is a schematic drawing of fixing means; and

FIGS. 4(a) and 4(b) are schematic drawings representing a support member.

### DETAILED DESCRIPTION OF THE PREFERRED EMBODIMENT

The following describes the preferred embodiments of the present invention with reference to drawings:

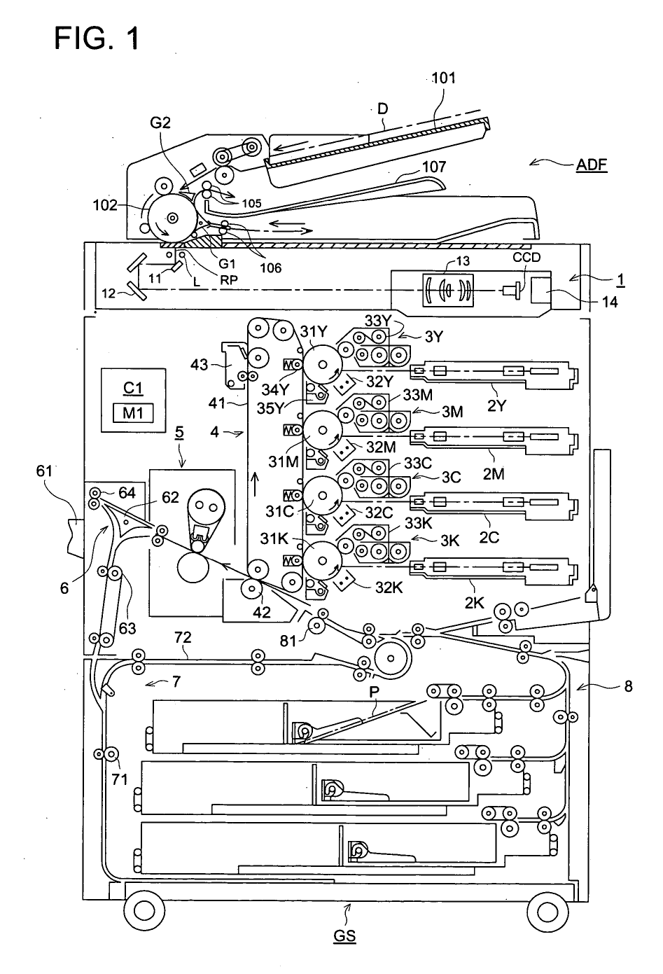

FIG. 1 is a schematic drawing of an image forming apparatus.

The image forming apparatus GS carries an automatic document feeder ADF mounted thereon. The document D placed on a document accommodation tray 101 of the automatic document feeder ADF are separated one by one. They are then fed out through a document transport path and are transported by a transport drum 102. The image of the document D being transported is read at the document image reading position RP by a document reading means 1. The document D having been read is ejected to a document ejection tray 107 by a first transport guide G1 and a document ejection roller 105.

When the document image on the back of the document D is read, the document D whose front face (first face) has been read is led to a document reversing roller 106 by the first transport guide G1, and is again fed out to the document transport path through the first transport guide G1 and second transport guide G2 by the document reversing roller 106 that is reversed with the trailing edge of the document interposed inbetween. The back face (second face) of the document D having been reversed and fed out is read out as in the case of the front face (first face), and is then ejected to the document ejection tray 107.

The image forming apparatus GS includes document reading means 1, image writing means 2Y, 2M, 2C and 2K, image forming means 3Y, 3M, 3C and 3K, image transfer means 4, fixing means 5, eject and reverse means 6, re-feed means 7, feed means 8 and control means C1.

Light is applied to the document image by a lamp L at the document reading position RP, and the reflected light is led by a first mirror unit 11, a second mirror unit 12 and a lens 13. The image is formed on the light receiving surface of an image pick-up device such as a CCD. The image signal having been subjected to photoelectric conversion by the image pick-up device CCD is subjected to analog-to-digital conversion, shading correction and compression by an image reading control section 14, and is stored in the memory M1 of the control means C1 as document image data.

Adequate image processing is applied to the document image data stored in the memory M1 according to the user's designation or the set conditions, whereby output image data is created.

Based on the output image data, scanning is applied to the surfaces of photoconductors 31Y, 31M, 31C and 31K as components of the image forming means 3Y, 3M, 3C and 3K, by the laser beam of the image writing means 2Y, 2M, 2C and 2K composed of a laser beam source, polygon mirror and a plurality of lens. Latent images are formed on the photoconductors 31Y, 31M, 31C and 31K.

Charging means 32Y, development means 33Y, transfer roller 34Y and cleaning means 35Y are arranged around the photoconductor 31Y. The same arrangement is applied to the photoconductors 31M, 31C and 31K. This configuration is composed of the known art adopted in the electrophotographic color image forming apparatus.

The latent images on the photoconductors 31Y, 31M, 31C and 31K are developed by the corresponding development means 33Y, 33M, 33C and 33K, and toner images are formed on the photoconductors. The toner images formed on the photoconductors 31Y, 31M, 31C and 31K are sequentially transferred onto predetermined positions on the transfer belt 41 by the first transfer rollers 34Y, 34M, 34C and 34K of the image transfer means 4.

The toner image transferred on the transfer belt 41 of the image transfer means 4 is fed by feed means 8, and is transferred by the second transfer roller 42 onto the paper P as a transfer material having been fed at intervals timed by a feed roller 81.

The transfer belt 41 having transferred the toner image on the paper P has its surface cleaned by cleaning means 43, and is used for the next image transfer.

The paper P carrying the toner image is fed to the fixing means 5 to be described later in detail, and the toner image is fixed on paper P when pressure and heat are applied thereto.

The paper P having been subjected to the processing of fixing by the fixing means 5 is transported by the eject and reverse means 6 and is ejected on an ejection tray 61. When the paper P is to be reversed and ejected, it is once fed downward by an ejection guide 62, and the trailing edge of the paper P is interposed by an eject and reverse roller 63. Then it is reversed and is ejected after being led to an ejection roller 64 by the ejection guide 62.

When an image is formed on the back face of paper P, the paper P on whose face the image has been fixed is fed by the ejection guide 62 to the re-feed means 7 located downward, and is fed backward with its trailing edge held by a re-fed reversing rollers 71, whereby paper P is reversed and fed to the re-feed transport path 72 so that the image is formed on the back face.

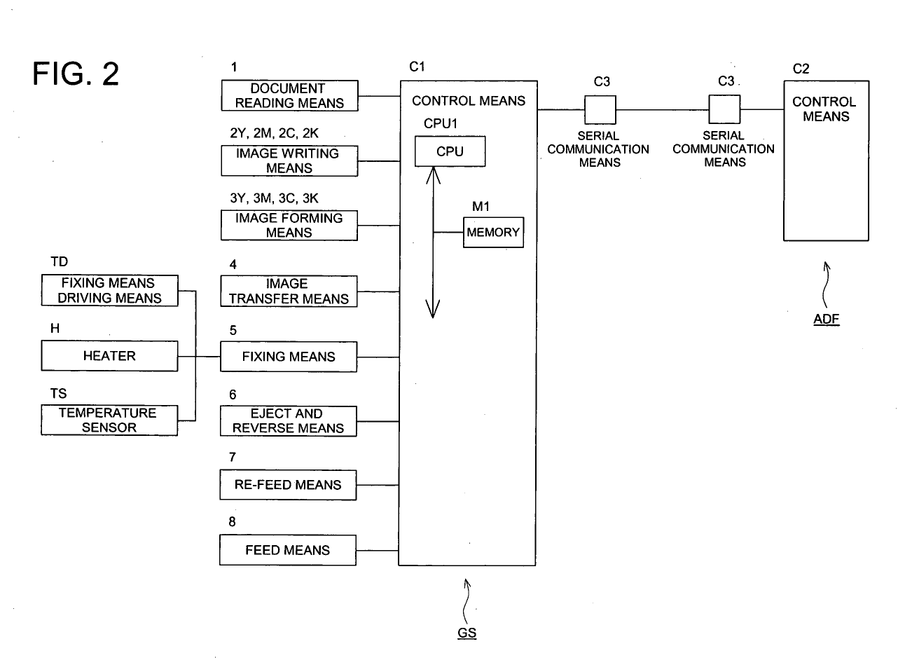

FIG. 2 is a block diagram representing the control of an image forming apparatus.

The control means C1 located on the image forming apparatus GS is a computer system comprising a CPU (CPU1), a memory M, I/O port and a communications interface and a circuit for controlling the drive of these means. The control means C1 on the automatic document feeder ADF is also a similar computer system although its size is smaller. The aforementioned control means C1 and control means C2 are connected via a serial communications means C3. In this drawing, the block not directly related to the explanation of this invention is not described.

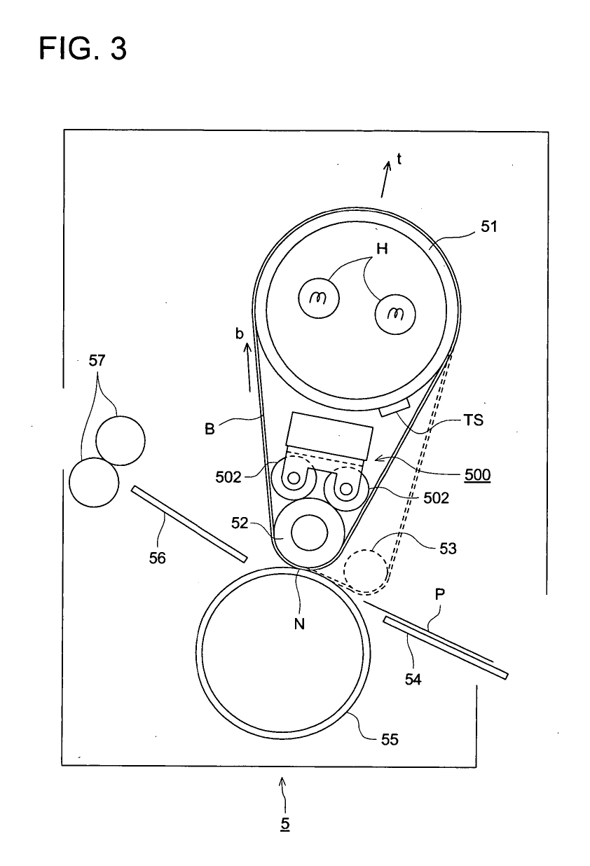

FIG. 3 is a schematic drawing of fixing means 5.

As shown in this drawing, the belt B having an elastic layer is entrained about a heating roller 51 and a first pressure roller 52 of a small diameter, and is turned in the arrow-marked direction. The tension of the belt B is adjusted by the tension adjusting means (not illustrated) of general type that pulls the heating roller 51 in the arrow-marked direction t. The belt B may be entrained using a guide roller 53 or a sliding member, as shown by the broken line of the drawing.

The belt B, first pressure roller 52 and heating roller 51 are rotated by the second pressure roller 55 driven by fixing means driving means TD (not illustrated). The belt B is heated by the heating roller 51 that incorporates a heater and rotates while supporting the fixing belt B. The surface temperature of the heating roller 51 is periodically measured by a temperature sensor TS. The result of measurements is captured by the control means C1, and the heater H is controlled so as to keep the temperature at a specified level.

The first pressure roller 52, not provided with an elastic layer having a reduced diameter for lower heat capacity, is supported by a support member 500, equipped with a plurality of support roller pairs 502 not provided with an elastic layer, and a belt B; and is rotated by the belt B. The control member for controlling the axial movement of the first pressure roller 52 will not be described since it is not directly related to the present invention.

The aforementioned support member 500 in the present embodiment has roller pairs. Instead of such roller pairs, it is possible to use a sliding pad including a heat-proof resin member (e.g. polyimide) of low heat conductivity and high strength coated with a fluorine resin sheet characterized by improved wear resistance. The preferred examples of the fluorine resin include polytetrafluoroethylene (PTFE) formed in across-linked structure or the one mixed with organic or inorganic microscopic particulates for improvement of wear resistance. It is also possible to apply grease to the heat-proof resin member, without using the covering sheet. In this case, however, it is preferable that the first pressure roller 52 be also rotated.

The paper P carrying the unfixed toner image is guided by the entry guide 54 to reach a nip N composed of the belt B and second pressure roller 55. The toner image on paper P is heated by contact with the fixing belt B, and is subjected to pressure and heat by the nip N composed of the first pressure roller 52, belt B and second pressure roller 55, whereby the toner image is fixed on paper P. The paper P with the image fixed thereon is guided by the ejection guide 56 and is fed to the aforementioned eject and reverse means 6 by an ejection roller 57.

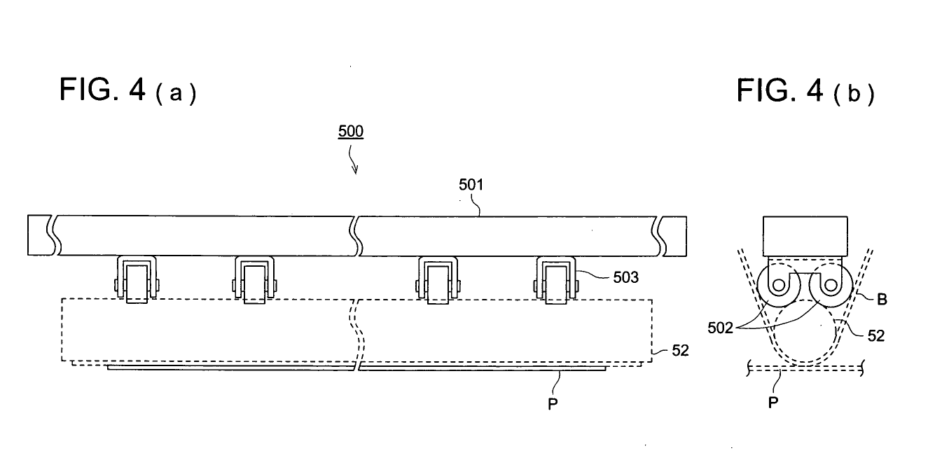

FIGS. 4(a) and 4(b) are schematic drawings representing the support member 500. FIG. 4(a) is a front view, and FIG. 4(b) a side view.

The support member 500 is composed of a support base 501, a support roller pair 502 and a roller pair holding member 503. The support base 501 has a sufficient strength to bending, and is mounted on the main structure of the fixing means 5.

The support roller pair 502 is composed of two rollers having no elastic layer, and is secured onto the support base 501 by the roller pair holding member 503.

As shown by the broken line in the drawing, the first pressure roller 52 is pressed against the support roller pair 502 by the tension of the belt B, and is rotated about a predetermined rotary center. Further, the support point of the support roller pair 502 supporting the first pressure roller 52 is located within the width of paper P. When paper P passed by, it serves to avoid bending of the first pressure roller 52 that is more likely to occur due to reduced diameter. Further, both the first pressure roller 52 and support roller pair 502 have no elastic layer on the surface, and have such a wall thickness that deformation of the cross section does not occur. This forms a contact between rigid bodies, with the result that the first pressure roller 52 is rotated by the support roller pair 502, with its position kept at a preferred linear state at all times.

Each of the first pressure roller 52 and the support roller pair 502 is not provided with an elastic layer such as rubber. However, a coating (thickness: several tens μm to 1 mm) made by a heat-proof resin such as polyimide may be applied to either one or both of the first pressure roller and the support roller pair to prevent wear.

Because of the aforementioned structure, a nip of uniform width and sufficient pressure is formed across the entire width of paper P between the belt B having an elastic layer and the second pressure roller 55 by the small-diameter first pressure roller 52, having no elastic layer, supported so as to avoid bending, whereby fixing means characterized by lower heat capacity and excellent fixing properties is provided. In this embodiment, the support roller pair 502 are provided on each of the roller pair holding member 503. However, the support roller pair 502 on each of the roller pair holding member 503 may be changed to be only one roller so that each roller on the roller pair holding member 503 may form a zigzag form, in the longitudinal direction of the support base 501, to be positioned at right and at left alternately when viewed in FIG. 4(b). With this structure, each of diameters of the support rollers can be made larger than that of the support roller pair shown in the drawing.

Further, it is preferable to make the diameter of the first pressure roller 52 to be smaller than 30 mm, thereby the curvature on the boundary between the belt B at the separation point and paper P is increased by the reduced diameter of the first pressure roller 52. Thus, the paper P with an image fixed thereon can be stably separated from the belt B.

The following describes the examples.
Heating roller: outer diameter: 50 mm; wall thickness: 1.5 mm; made of aluminum, PFA coating: 20 microns thick
Belt (endless belt of layered structure): diameter: 80 mm; polyimide thickness: 100 μm; silicone rubber thickness 200 μm; PFA thickness: 30 μm
Support roller pair:
Roller used: outer diameter: 11 mm; width: 4 mm; a heat-proof roller bearing with a dynamic constant load of 960N
First pressure roller: outer diameter: 15 mm; width: 4 mm; made of ion
Second pressure roller: outer diameter: 40-60 mm
The core metal is coated with JISA silicone rubber having a thickness of 3 through 8 mm at 20 through 30 deg.
Pressure: 500 through 1000 N

Under these conditions, formation was made based on a comparatively small nip width of 4 through 6 mm and a large pressure of 400 kPa or more, and excellent fixing results have been achieved.

In the aforementioned embodiment, the first pressure roller shaft is a movable roller, and the second pressure roller 55 is a drive roller. It is also possible to make such arrangements that the first pressure roller shaft is fixed and the first pressure roller 52 is a drive roller. In this case, however, the support roller pair 502 is made to contact the peripheral surface of the first pressure roller 52 in the phase of assembling the fixing means 5; alternatively, the fixing means is assembled so as to have such a gap (0.05 through 0.1 mm in the present embodiment) that there is no problem even if bending has occurred to the first pressure roller 52. The first pressure roller 52 and support roller pair 502 are brought into close contact with each other at a predetermined position by the pressure of the second pressure roller 55.

The above description applies to the cases where both the first pressure roller 52 and second pressure roller 55 are driven; therefore, description will be omitted to avoid duplication.

1. An image forming apparatus having a fixing device for fixing on a sheet a toner image formed on the sheet by applying heat and pressure, the fixing device comprising:
(a) a belt having an elastic layer for applying heat and pressure to the sheet;
(b) a first pressure roller having no elastic layer on an outer periphery thereof, arranged inside the belt; and
(c) a second pressure roller, provided opposite to the first pressure roller through the belt and the sheet, for applying pressure to the belt and the sheet; and
(d) a support member for supporting the first pressure roller,
wherein support points of the support member are located within a width of the sheet passing between the belt and the second pressure roller.

2. The image forming apparatus of claim 1, wherein the first pressure roller is a follower roller.

3. The image forming apparatus of claim 1, wherein the support member has a plurality of supporting rollers.

4. The image forming apparatus of claim 1, wherein the support member is a sliding pad.

5. The image forming apparatus of claim 4, wherein the sliding pad is made by a heat-proof resin coated with a resin.

6. The image forming apparatus of claim 4, wherein the sliding pad is covered by a heat-proof resin to which grease is applied.

7. The image forming apparatus of claim 1, further comprising a drive source for driving the second pressure roller.

8. The image forming apparatus of claim 1, further comprising a guide roller provided inside the belt for guiding the belt.

9. The image forming apparatus of claim 3, wherein each of the plurality of supporting rollers has no elastic layer.

10. An image forming apparatus having a fixing device for fixing on a sheet a toner image formed on the sheet by applying heat and pressure, the fixing device comprising:
(a) a belt having an elastic layer for applying heat and pressure to the sheet;
(b) a first pressure roller having no elastic layer on an outer periphery thereof, arranged inside the belt;
(c) a second pressure roller, provided opposite to the first pressure roller through the belt and the sheet, for apply pressure to the belt and the sheet; and
(d) supporting roller pairs for supporting the first pressure roller at a plurality of supporting points.

11. The image forming apparatus of claim 10, wherein the first pressure roller is a follower roller.

12. The image forming apparatus of claim 10, further comprising a drive source for driving the second pressure roller.

13. The image forming apparatus of claim 3, wherein each of the supporting roller pair has no elastic layer.
